(19) United States
(12) Patent Application Publication
(10) Pub. No.: US 2009/0014605 A1
(43) Pub. Date: Jan. 15, 2009

(54) RECORDING DEVICE SUPPORT

(76) Inventor: Craig Kehl, Sandy, UT (US)

Correspondence Address: STOEL RIVES LLP - SLC, 201 SOUTH MAIN STREET, ONE UTAH CENTER, SALT LAKE CITY, UT, 84111, US

(21) Appl. No.: 12/172,091

(22) Filed: Jul. 11, 2008

Related U.S. Application Data
(60) Provisional application No. 60/949,363, filed on Jul. 12, 2007.

(51) Int. Cl. F16M 11/00

(52) U.S. Cl. 248/161

(57) ABSTRACT

Apparatus for supporting a recording device to facilitate recording of images, video, and/or sound from a position elevated above a subject. The apparatus may be dynamically and smoothly adjusted to track a moving subject. Further, the apparatus may allow a user to remotely control a recording device to smoothly record a moving subject from a position distal to the recording device.

### CROSS-REFERENCE TO RELATED APPLICATIONS

This application claims the benefit of U.S. Provisional Application No. 60/949,363, filed Jul. 12, 2007, which is incorporated herein by reference.

### TECHNICAL FIELD

The present disclosure relates to an apparatus for supporting a recording device to facilitate recording of images, video, and/or sound from a position elevated above a subject.

### BRIEF DESCRIPTION OF THE DRAWINGS

Understanding that drawings depict only typical embodiments of a recording device support and are not therefore to be considered to be limiting of its scope, the recording device support will be described and explained with specificity and detail through the use of the accompanying drawings as listed below.

FIG. 1 is a front plan view of a recording device support as taught herein;

FIG. 2 is a front plan view of the device mount portion of the recording device support of FIG. 1 showing the configuration of the device mount and its control and support mechanisms;

FIG. 3 is a side plan view of the device mount portion of the recording device support shown in FIGS. 1 and 2;

FIG. 4 is an angled perspective view of the device mount portion of a recording device support;

FIG. 5 is a rear view of the device mount portion of the recording device support of FIG. 4;

FIG. 6 is a side angle view of the recording device support of FIGS. 4 and 5 shown with a digital video camera mounted thereon;

FIG. 7 is an isolated view of a controller operably attached to a control arm of a recording device support;

FIG. 8 is a partial view of a recording device support isolating a view of the base and monitor enclosed by a shroud, projecting from the extensible mast of the apparatus; and

FIG. 9 is a full view of the recording device support showing the extensible mast, a tripod base, control arms with tilt control on a left side and a zoom control on a right side mounted to the extensible mast, a monitor encased by a shroud, and a digital video recorder deployed and mounted at the top of the mast shown stabilized with optional stabilizing cables.

### DETAILED DESCRIPTION OF PREFERRED EMBODIMENTS

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, but is merely representative of various embodiments. While the various aspects of the embodiments are presented in drawings, the drawings are not necessarily drawn to scale unless specifically indicated.

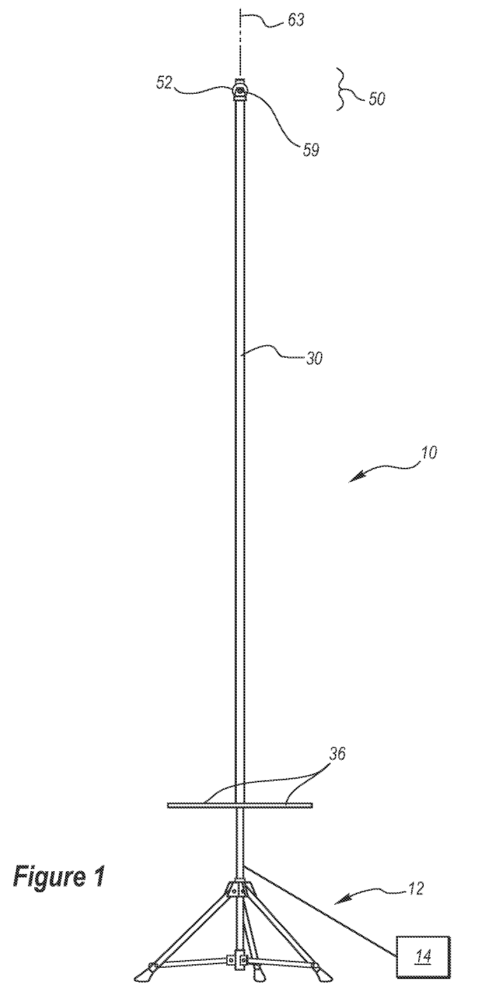

Referring first to FIG. 1, a recording device support 10 is shown in a front plan view. Recording device supports 10, such as shown in FIG. 1, allow a device such as a still camera or video camera to be positioned at a height distal to the operator in order to more effectively view and record photographs, audio, or video of a subject. Subjects that benefit from such recording systems often include large groupings of people or objects, panoramas, sporting events, and the like. Further, it should be noted that the recording device supports may be adapted to be specifically useful for subjects that are moving or dynamic, such as participants in sporting events, and which are thus difficult to record. The recording device supports thus allow a recording device to be controlled by an operator distal to the controls of the device and allow the recording device to be moved and angled smoothly to follow the movement or activity of a subject, such as, in one example, recording the movement of a ball or a player on a field during a sporting event.

Thus, recording device support 10 of FIG. 1 includes a base portion 12, a mast 30, and a device mount 50. Referring first to the base portion 12, the supports 10 may be constructed to be semi-permanent installations, modular and assembled to a permanent base, or completely portable and capable of being fully transported and utilized in a temporary manner. In permanent or semi-permanent installations, the base portion 12 may be installed in a location in any suitable manner for such an installation, including, without limitation, being set into the ground, being cemented into place, or being attached to a permanent or other stable structure. In many instances it may be beneficial to have a base portion 12 segment of the supports 10 mounted in such a manner, while the remainder of the apparatus is modular, and is thus able to be attached thereto when it is desired to be used.

In other configurations, such as that illustrated in FIG. 1, the base portion 12 is portable to allow the support 10 to be transported as a whole. In such configurations, the base portion 12 may take a wide variety of forms known within the art. As illustrated in FIG. 1, in some embodiments, the base portion 12 may be a collapsible tripod adapted for portability and assembly where needed. Further, the legs of the tripod base portion 12 may be independently extensible. This allows the device 10 to be placed on uneven or sloped ground, steps, or other non-level surfaces and to still be made level by adjustment of the lengths of individual legs. In other embodiments, the base 12 may be a broad, flat structure with a connector for receiving the mast 30. Other similar configurations are known to those of skill in the art.

The size and configuration of the base portion 12 may be adjusted between embodiments of the recording device supports 10 to allow for variation in the size of the recording device to be used and the portability requirements for the supports 10.

The recording device supports 10 further include a mast 30. The mast 30 of the supports 10 allows a recording device (not shown) to be placed vertically such that it gives a user an aerial view of a subject. Aerial views such as those provided by the recording device supports 10 may be useful in crowded environments and those in which a subject is large or more clearly or effectively observed from above. Aerial views can be set at a proper angle so as to provide the optimal amount of height, width and depth information to a viewer. This may be useful to a coach interested in analyzing the depth and spacing between players on the field during play. In some embodiments, the recording device supports 10 elevate the recording device from about 10 to about 35 feet above the ground. In others, the recording device supports 10 elevate the recording device from about 20 to about 35 feet above the ground. In other embodiments, the supports 10 elevate the recording device from about 25 to about 35 feet above the ground. The mast 30 of the supports may accomplish this in a variety of ways.

In some embodiments, the mast 30 is a unitary structure having a fixed length and size. Such supports 10 may be less easy to transport, and thus better suited for more permanent installations. In other embodiments, the mast 30 of the support 10 may be extensible to allow it to provide height while remaining more easily portable. Such extensible masts 30 may be provided in a manner of ways. It is known in the art to provide masts that assemble from a set of connectable segments, masts which segments which nest within each other for transportation, telescoping masts, and others.

In some configurations, recording device supports 10 utilize telescoping masts 30 to provide height in a smaller overall device size when not deployed. Suitable telescoping masts 30 are well known in the art and may have a variety of shapes and sizes to provide the desired function.

Recording device supports 10 may rotate to allow the lens of the recording device mounted thereto (not shown) to rotate about a vertical axis 63. As discussed briefly above, such action may be desirable to assist a user in simply redirecting the device for a new recording, or it may be useful in tracking the movement of a subject such as an athlete participating in a sports event or a ball in play during such an event. Rotation of the mast 30 about a vertical axis 63 may be facilitated by inclusion of a control arm or arms 36. To operate, a user (not shown) grasps the arm or arms 36 and rotates the mast 30 to direct the lens of the recording device. Such motion is intuitive to many users. Arms 36 may further be used to mount additional controls for the recording device. Controls such as arms 36 are intuitive to a new user of the supports 10, and thus render the device easy to use, and easy to train new operators to use.

In some alternative configurations, arms 36 could be configured such that their position and size may be adjusted to meet the physical characteristics of users of the device. Specifically, the arms 36 could be made to be raised or lowered on the mast 30, or made longer or shorter as required by a user. Controls such as arms 36 could be further configured to be moved closer to or out further from the mast 30 to provide the optimum amount of leverage for users of different physical characteristics to gain the smoothest amount of control when rotating the mast 30 such as to follow a fast moving ball.

The recording device supports 10 further include a device mount 50, including a pivot 52. The device mount 50 typically includes a mounting adapter 56 (in many instances a standardly-sized mounting screw known and used in the art for mounting cameras and video recorders to tripods or stands) or other suitable mounting device to securely attach a recording device to the support 10. The device mount 50 further includes a pivot 52 that allows the recording device to be angled upward or downward about a horizontal axis 59 by the directions of a user. Movement of the pivot is opposed by springs 54, which are adapted to neutralize or reduce the effects of gravity on a recording device attached to the mount 50. This allows the mount to be positioned or angled by the application of a lesser force than required otherwise, and to counter the forces of gravity, which may otherwise interfere with smooth adjustment of the position or angle of the recording device, especially when tilting the device up or down rapidly.

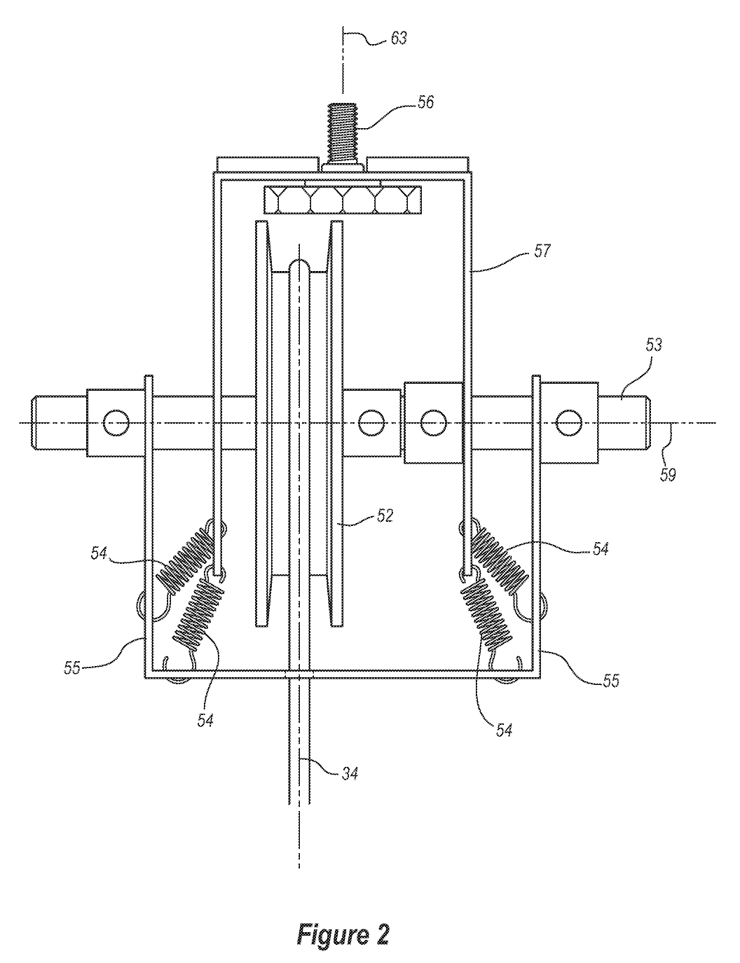

Referring next to FIG. 2, a front plan view of the device mount portion 50 of the recording device support 10 of FIG. 1 is provided to show the configuration of the device mount 50 and its control and support mechanisms 34, 54. First, the device mount 50 includes the pivot 52, shown here in the form of a wheel. The mount 50 further includes an adapter 56 described above, placed on an adapter housing 57 for attachment to a recording device (not shown).

The pivot 52 rotates about an axle 53, defining a horizontal axis 59, and is shown to be rotated by a cable 34 run through the pivot 52 and drawn by the user to rotate the pivot 52. Rotation of the pivot 52 rotates the axle 53, and thus rotates the adapter housing 57 about the axis 59, raising or lowering the lens of the recording device accordingly. Tension placed upon the cable 34 keeps the device mount 50 stable, thus providing a steady platform for recording during use of the device. Further, during adjustment of the position or angle of the recording device, the tension maintained on the cable 34 provides smooth transitions and adjustments.

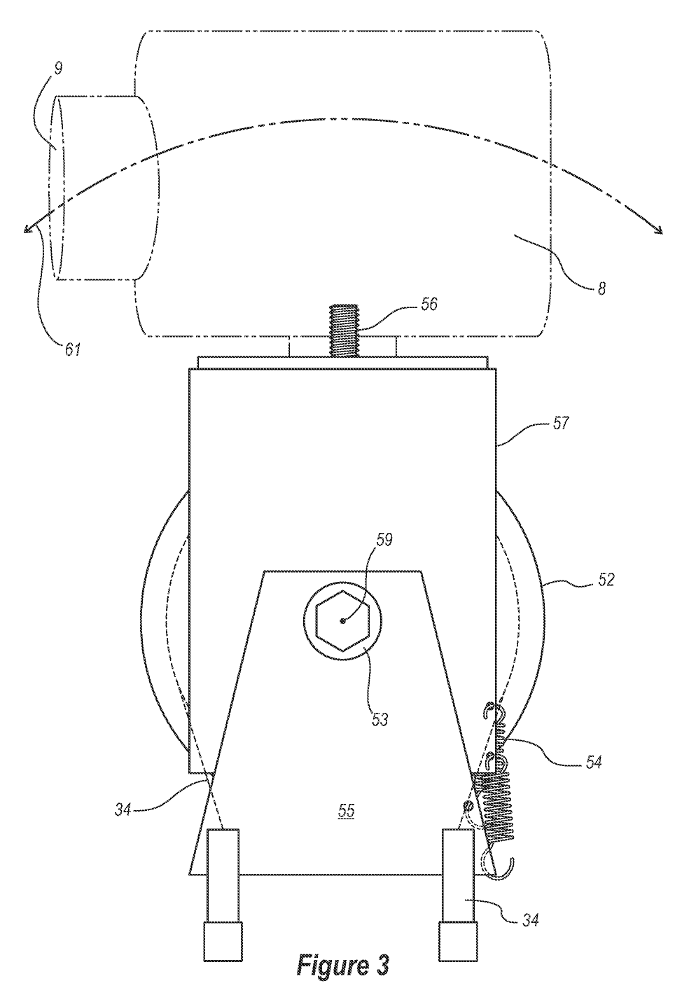

FIG. 3 is a side plan view of the device mount portion of the recording device support of FIGS. 1 and 2. FIG. 3 illustrates the rotation of the device mount 50, and correspondingly, a recording device 8, about the axis 59. This rotation causes a lens 9 of the device 8 to travel along an arc such as 61 (the exact position and length of which will vary based upon variables including the size of the recording device 8, the height and shape of the device mount 50, and the adapter 56. This rotation along an arc 61 located above the axis 59 provides improved ability to view a subject from above and allows greater control of the rotation of the device mount 50.

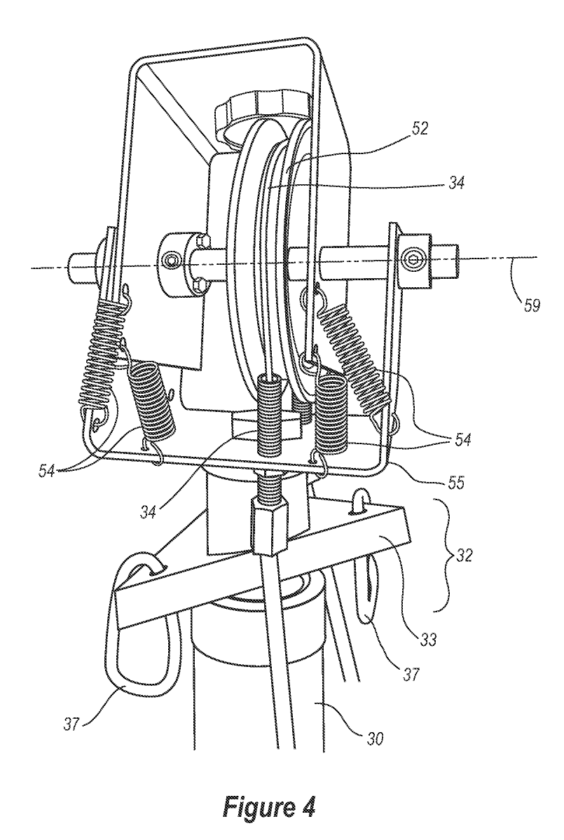

FIG. 4 provides an angled perspective view of the device mount portion 50 of a recording device support 10. As in previous FIGS. 1-3, the device mount portion 50 is shown to include the pivot 52, a cable 34, counterweights or springs 54, an adapter 56 carried on the adapter housing 57, the adapter housing 57 being rotated about a horizontal axis 59 by rotation of the axle 53 when the cable 34 is actuated, turning the pivot 52. The device mount 50 is further shown to include a mast housing 55 which carries, but is not rotated by, the axle 53, and thus supports the device mount 50. The mast housing 55 further attaches the device mount 50 to the mast 30.

In one embodiment, the pivot 52 of the device mount 50 includes counterweights or springs 54 mounted to support, at least in part, the weight of the recording device (not shown). This configuration may prevent the weight of the recording device from being felt (at least in part) during vertical rotation of the lens. As illustrated, the counterweights or springs 54 are mounted to oppose tilting of the recording device in a selected direction, thus rendering the vertical orientation of the device more simple to control by reducing the force required to rotate the device mount 50. More importantly, this allows for smoother and more accurate reversal of direction or stopping of movement of the recording device as may be required in following fast moving action.

FIG. 4 further illustrates optional stabilizing features to reduce movement of the recording device (not shown) attached to the recording device support 10. More specifically, the support 10 of FIG. 4 is illustrated to include stabilizing cables 32. The number and orientation of such stabilizing cables 32 may vary with the size of the recording device selected, since heavier devices or larger recording devices may require more stabilization to assist in obtaining clear recordings. In addition, further stabilization may be useful in environments with significant wind that may cause movement of the recording device.

In some instances, such stabilizing cables 32 may be mounted to the mast 30 at its top, as in FIG. 4, while in others, cables 32 may be mounted at another site lower on the mast 30. Cables 32 are attached to the mast 30 so as to allow them to remain a relatively fixed position during rotation of the device mount 50 placed on the mast 30. This may be accomplished by attaching them to a non-rotating section of the mast 30, or they may be mounted to another structure associated with the mast 30, such as the triangular attachment 33 shown on FIG. 4, via the loop connectors 37. The stabilizing cables 32 are then attached on their distal end to the ground or to another stable structure or object.

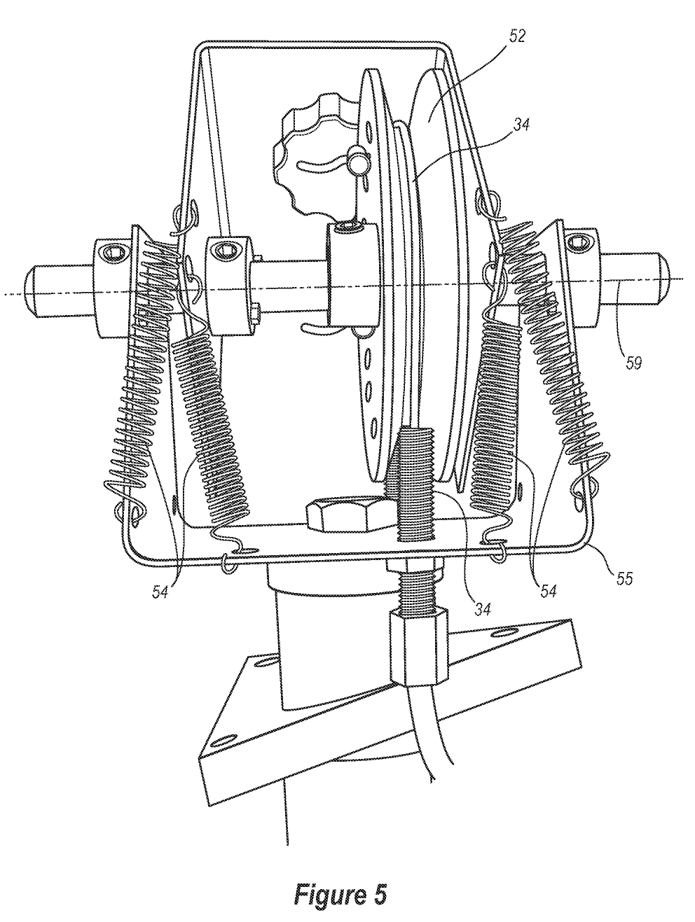

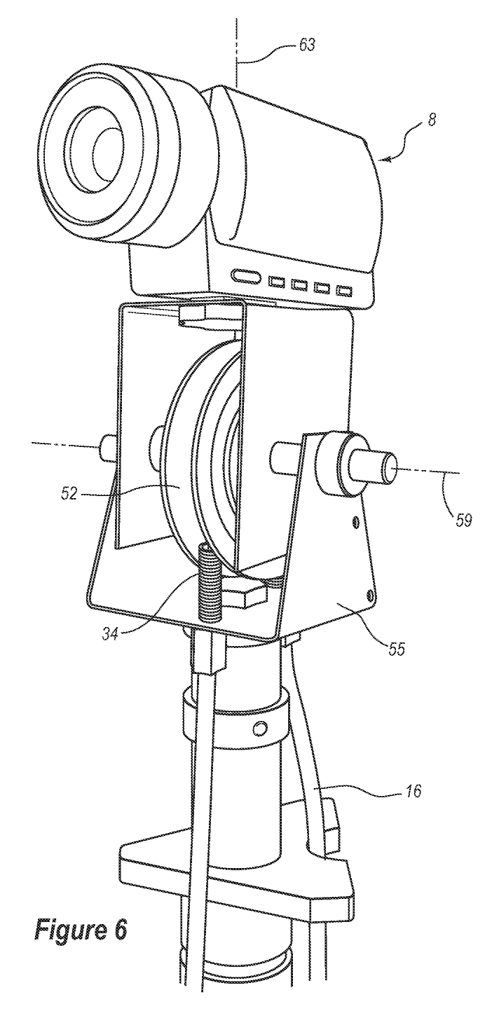

FIG. 5 illustrates the support device 10 of FIGS. 1-4 in a rear view, detailing placement and orientation of the counterweights or springs 54 of the device mount portion 50 on the adapter housing 57, relative to the mast housing 55. FIG. 6 illustrates a digital video recording device 8 mounted to the device mount portion 50 of the support 10 of FIGS. 1-5.

As an operator views the subjects being recorded on the monitor 20 situated on the recording device supports 10, the operator may tilt the camera about the horizontal axis 59 or pan the recording device 8 about a vertical axis 63 defined in most instances by the mast 30, to assure recording of the desired subject. This control is facilitated by providing controls to allow tilting and rotation of the recording device such as the arms 36 shown extending from the mast 30 that allow a user to rotate the mast 30 and thus the recording device 8. Use of the stand 10 may be facilitated by mounting the monitor 20 to the mast 30 such that it rotates with the mast 30 to allow a user to smoothly follow the subject during large rotations of the mast. In other embodiments of the supports 10, such as those adapted for use over a narrower subject, it may be advantageous to mount the monitor 20 in a non-rotating manner, or to a non-rotating portion of the mast 30 to allow a user to stand still, observing the subject on the monitor 20, while adjusting the view recorded by the recording device by arm movements only.

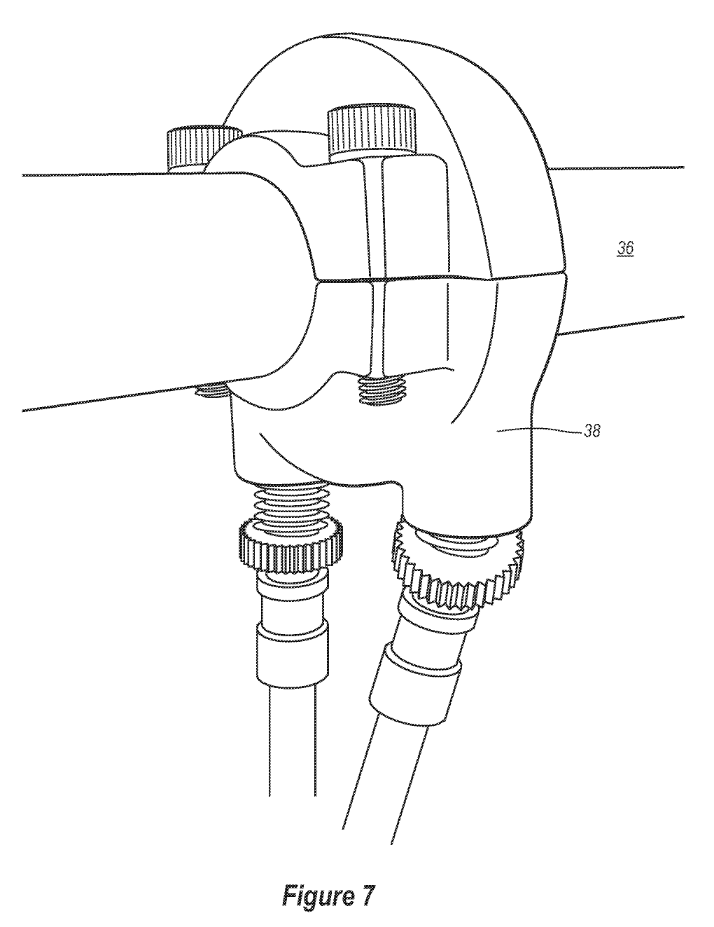

As described in brief above, adjustments to the vertical orientation of the recording device are made by drawing a cable 34 through a pivot 52, rotating the adapter housing 57 and thus angling the lens upwardly or downwardly about a horizontal axis 59. A wide variety of tilt controls may be used to facilitate such rotation. In one embodiment, actuation of a tilt control 38 such as that illustrated in FIG. 7, mounted to an arm 36 draws a cable 34 run through the wheel 52 (not shown), lifting the recording device 8 (not shown). Release of the control 38 allows the recording device to remain still, having its weight counter balanced by the springs 54. The balanced tension provided by the cable 34 provides a pull and push balanced force at all times giving the advantage over conventional methods by providing more accurate movement as required when following higher speed subjects such as a lacrosse ball. This push and pull force provided by the cable 34 helps to stabilize the device mount 50, and to provide smooth, even adjustment of the position and angle of the device mount 50. This is helped by the neutralization of the additional force of gravity by the springs 54, which reduces the force of downward movement of a recording device, reducing the effort required in the case that direction needs to be easily, quickly and accurately reversed. This control 38 may in some embodiments be a throttle-style controller such as that found on motorcycles or other similar devices, as illustrated in FIG. 7. Such controllers may allow a user to quickly, smoothly, and intuitively control vertical rotation of the recording device 8.

A camera rotational control 60 is also provided to facilitate panning of the camera by rotation of the recording device 8 about a vertical axis 63. In some embodiments, this control 60 may be a rotatable device mount controlled by the camera operator. In some specific embodiments, the control 60 may be the control arm or arms 36 mounted to a rotatable element attached to the device mount 50. In some embodiments, the rotatable element may be the mast 30 carrying the device mount 50. In others, the rotatable element may travel within the mast and communicate operably with the device mount 50. In this way, the mast 30 may be rotated periscope-style by a user to control the device.

The recording device supports 10 may further comprise additional controls to facilitate use of the recording device mounted thereto. In one embodiment, the camera stand 10 may comprise controls to turn the recording device on or off, zoom the lens of the recording device 8 in and out, and to start and/or stop recording. Such controls are known, and may be provided by mounting a controller device such as a 521 controller (e.g., Amphoto™) to a control arm 36 of the mast 30, placing it within reach of a user.

Similarly, recording device supports 10 may further include a power source for the recording device 8 to prolong its use. Although many such recording devices 8 utilize battery power, the lifetime of such power is limited and may be extended by connecting the device 8 to an external battery or power source. This may be accomplished by a power cord running from the device 8 along the mast 30 to a power source. Power sources may include batteries, AC power, and other sources suitable to power recording devices 8.

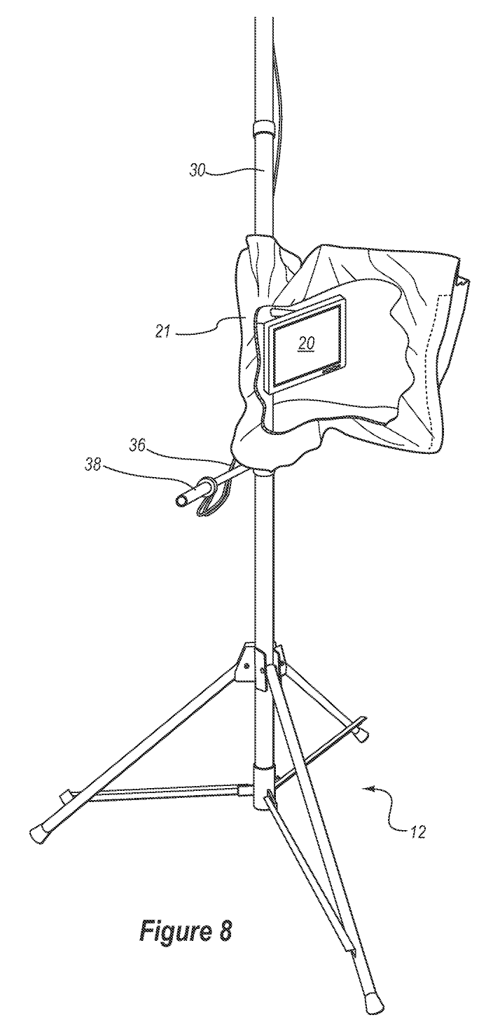

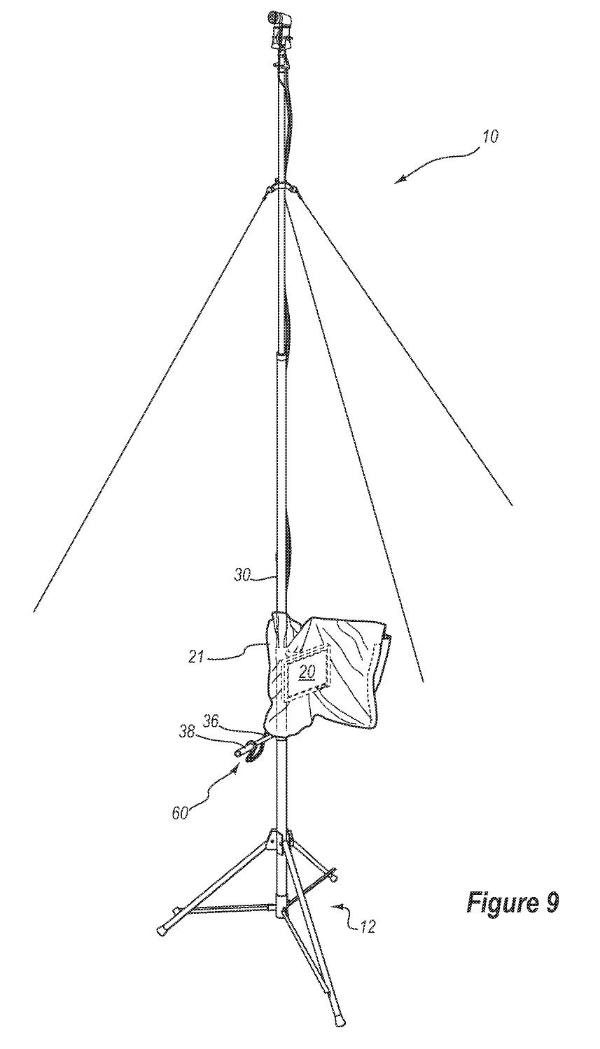

Referring next to FIGS. 8 and 9, the device mounts 50 of the camera stands 10 allow the recording device 8 to be smoothly rotated about the vertical axis 63 and tilted about the horizontal axis 59 to locate a subject or to track a moving subject by the actions of an operator on the ground. To facilitate recording, the stands 10 may further provide a video link 16 between the recording device 8 and a monitor 20 placed at a height viewable to the operator, allowing the operator to view the images being recorded. In these embodiments of the recording device supports 10, a power source 14 may additionally be provided for the recording device 8 and/or for the monitor 20. In some configurations, the monitor 20 used may be a simple television or computer monitor such as an LCD monitor. In particular configurations, it may be useful to utilize a monitor 20 with good outdoor viewing characteristics. In others, a shroud 21 may be provided about the monitor 20 to give privacy to the user and to assist in avoiding glare and maintaining focus on the subject being filmed during filming.

In many embodiments, the recording device support 10 is modular, with components such as the base portion 12, mast 30, and device mount 50 being capable of being detached from each other to simplify transportation of the devices 10. Similarly, components such as a monitor 20, power source, stabilizing cables, and/or shrouds 21 may be capable of disassembly from each other to simplify transportation and/or storage of the supports 10. In embodiments employing fixed base portions 12, the remaining portions of the support 10 may be detached from a fixed base portion 12 in one location and transported to alternative locations for use with either another fixed base 12 or a portable base such as the tripod base illustrated and described herein or with another base portion 12.

Without further elaboration, it is believed that one skilled in the art can use the preceding description to utilize the present disclosure to its fullest extent. The examples and embodiments disclosed herein are to be construed as merely illustrative and not a limitation of the scope of the present disclosure in any way. It will be apparent to those having skill in the art that changes may be made to the details of the above-described embodiments without departing from the underlying principles of the disclosure described herein. In other words, various modifications and improvements of the embodiments specifically disclosed in the description above are within the scope of the appended claims. The scope of the invention is, therefore, defined by the following claims. The words “including” and “having,” as used herein, including the claims, shall have the same meaning as the word “comprising.”

1. A device support comprising:
a base portion adapted to stabilize the support;
a vertically extensible, axially rotatable mast extending upwardly from the base portion;
at least one control arm mounted to the mast for controlling rotation of the mast about a vertical axis; and
a horizontally rotatable device mount atop the vertical mast, the device mount being rotated about a horizontal axis by a horizontal rotation control mounted on the control arm, wherein rotation of the horizontal rotation control causes a corresponding rotation of the device mount about the horizontal axis.

2. The device support of claim 1, wherein the base is portable.

3. The device support of claim 2, wherein the base is a tripod.

4. The device support of claim 1, wherein the device support is modular.

5. The device support of claim 1, wherein the mast is extensible to position a recording device to a height of from about 10 to about 35 feet above the ground.

6. The device support of claim 5, wherein the mast is extensible to position a recording device to a height of from about 10 to about 35 feet above the ground.

7. The device support of claim 1, wherein the device support comprises two control arms.

8. The device support of claim 7, wherein the control arms are placed at the same vertical height on the mast.

9. The device support of claim 7, wherein the control arms are angled perpendicularly to the mast.

10. The device support of claim 1, wherein the control arm further comprises controls to remotely control a recording device positioned on the support.

11. The device support of claim 1, wherein the device mount further comprises a counterweight or springs to at least partially support the weight of a recording device positioned on the support.

12. The device support of claim 1, further comprising a monitor configured to be operably linked to a recording device positioned on the support.

13. The device support of claim 1, wherein the device mount further comprises a wheel adapted to be rotated by a cable controlled by a user about a horizontal axis to raise or lower a lens of a recording device positioned on the support.

14. The device support of claim 13, wherein the wheel is adapted to be rotated by a throttle as a cable control.

15. A portable device support comprising:
a tripod base portion adapted to stabilize the support;
a vertically extensible mast rotatable about a vertical axis extending upwardly from the base portion, the mast comprising a pair of control arms to facilitate the rotation of the mast about the vertical axis;
a video monitor attached to the mast adapted to be operably linked to a recording device positioned on the support; and
a horizontally rotatable device mount atop the vertical mast, the device mount being rotatable about a horizontal axis by a horizontal rotation control positioned on a control arm, wherein rotation of the horizontal rotation control causes a corresponding rotation of the device mount about the horizontal axis, the device mount further including a device attachment for securing a device to the support.

16. The portable device support of claim 15, wherein the support is modular.

17. The portable device support of claim 15, wherein the control arms further comprise remote controls adapted to control actuation and operation of a recording device positioned on the support.

18. The portable recording device support of claim 15, wherein the device mount further comprises a counterweight or springs to at least partially support the weight of a recording device positioned on the support.

19. A portable recording device support comprising:
a base portion adapted to stabilize the support;
a vertically extensible mast rotatable about a vertical axis extending upwardly from the base portion, the mast comprising a pair of control arms to facilitate rotation of the mast about the vertical axis;
a video monitor attached to the mast adapted to be operably linked to a recording device positioned on the support; and
a horizontally rotatable device mount atop the vertical mast, the device mount being rotatable about a horizontal axis by a horizontal rotation control positioned on a control arm wherein rotation of the horizontal rotation control causes the lens of a recording device secured to the support to travel along an arc located above the horizontal axis, wherein the device mount further includes a device attachment for securing a device to the support.

20. The portable recording device support of claim 19, wherein the device mount further comprises a counterweight or springs to at least partially support the weight of a recording device positioned on the support, thus lessening the force required to rotate the horizontal rotation control and to cause the lens of a recording device positioned on the support to travel along an arc located above the horizontal axis.
